(19) United States
(12) Patent Application Publication
(10) Pub. No.: US 2011/0194823 A1
(43) Pub. Date: Aug. 11, 2011

(54) CABLE ASSEMBLY WITH ELECRICAL AND OPTICAL TRANSMITTING

(75) Inventor: JERRY WU, Irvine, CA (US)

(73) Assignee: HON HAI PRECISION INDUSTRY CO., LTD., New Taipei (TW)

(21) Appl. No.: 13/015,322

(22) Filed: Jan. 27, 2011

(30) Foreign Application Priority Data
Feb. 9, 2010 (CN) 201020302665.5

(51) Int. Cl. G02B 6/36

(52) U.S. Cl. 385/92

(57) ABSTRACT

An cable assembly includes an insulative housing (1) having a cavity (104) and a depression (105) respectively located in an upper side and a lower side of a front segment thereof; a plurality of terminals (212, 222) received in the insulative housing, with contacting portions thereof accommodated in the cavity; an optical module (8) accommodated in the depression, said optical module having a seat and a number of lenses supported by the seat; and a cable (6) having a plurality of wires (61) and fibers (65) connected to the terminals and the lenses, respectively.

### FIELD OF THE INVENTION

The present invention generally relates to a cable assembly, and more particularly to a cable assembly adapted for electrical and optical transmitting.

### DESCRIPTION OF PRIOR ART

Nowadays, an electrical device has become lower profile and multi-functional, and a cable assembly for the electrical device is also capable of high-speed transmitting, and reliably connection and easily detachable with its counterpart.

Cable assemblies in accordance with USB, SATA, HDMI, SAS and Displayport protocol have been widely applied in different kinds of electronic devices. The aforementioned cable assemblies depend on metallic terminals and copper wires to achieve electrical signal transmitting. However, transmitting speed is limited via electrical signal transmitting. In other aspect, as transmitting speed increasing, a structure of the cable assembly becomes complex, and a total dimension of the cable assembly is increasing.

Hence, an improved cable assembly is highly desired to overcome the aforementioned problems.

### SUMMARY OF THE INVENTION

Accordingly, an object of the present invention is to provide a lower profile and easily manufactured cable assembly.

In order to achieve the object set forth, a cable assembly in accordance with the present invention comprises an insulative housing having a cavity and a depression respectively located in an upper side and a lower side of a front segment thereof; a plurality of terminals received in the insulative housing, with contacting portions thereof accommodated in the cavity; an optical module accommodated in the depression, said optical module having a seat and a number of lenses supported by the seat; and a cable having a plurality of wires and fibers connected to the terminals and the lenses, respectively.

Other objects, advantages and novel features of the invention will become more apparent from the following detailed description when taken in conjunction with the accompanying drawings.

### BRIEF DESCRIPTION OF THE DRAWINGS

FIG. 1 is an exploded, perspective view of a cable assembly in accordance with the present invention;

FIG. 2 is similar to FIG. 1, but viewed from another aspect;

FIG. 3 is a partially assembled view of the cable assembly;

FIG. 4 is similar to FIG. 3, but viewed from other direction;

FIG. 5 is other assembled, perspective view of the cable assembly;

FIG. 6 is similar to FIG. 5, but viewed from other direction;

FIG. 7 is an assembled, perspective view of the cable assembly; and

FIG. 8 is a cross-section view taken along line 8-8 of FIG. 7.

### DETAILED DESCRIPTION OF PREFERRED EMBODIMENTS

Reference will now be made in detail to the preferred embodiment of the present invention.

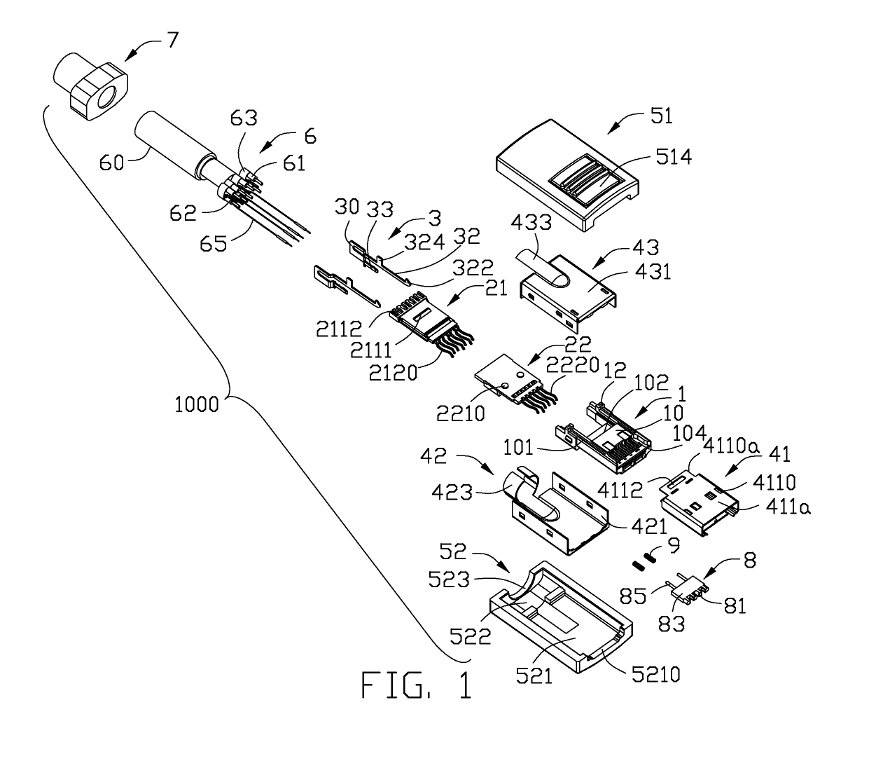

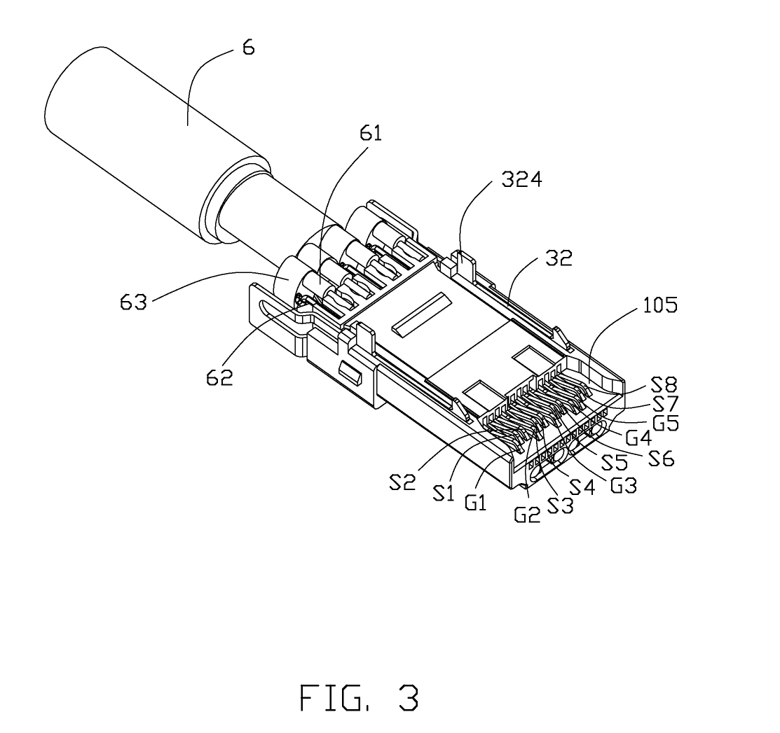

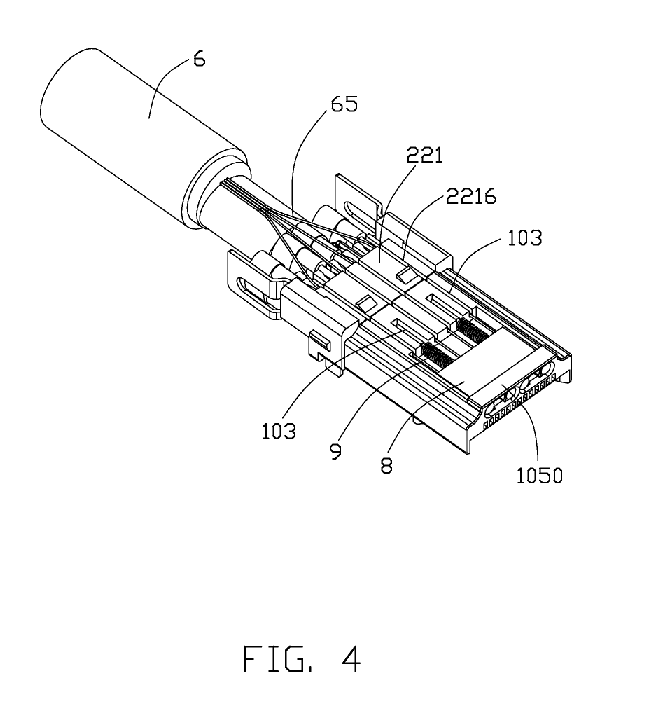

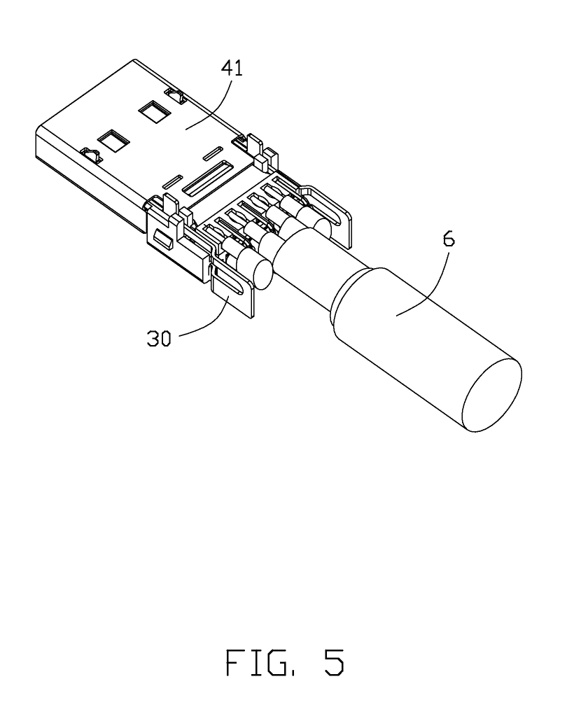

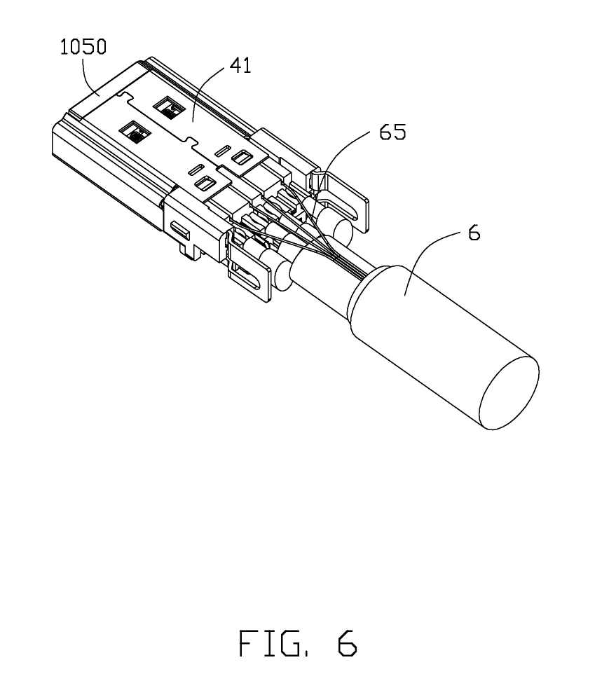

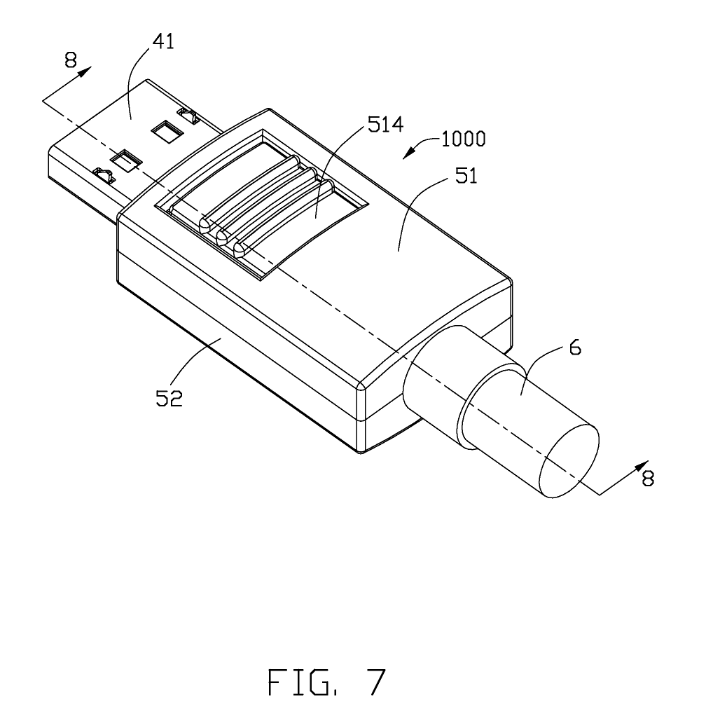

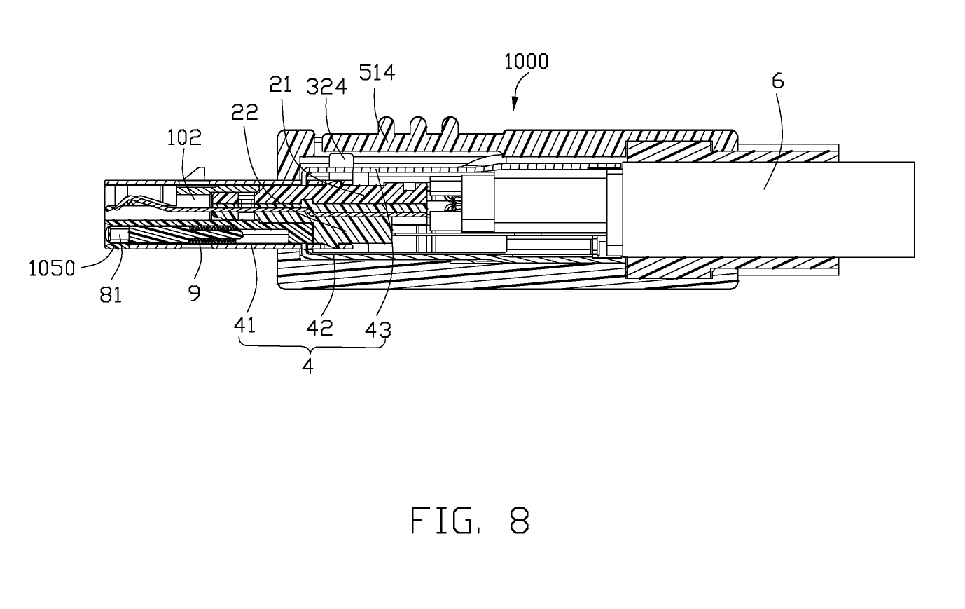

Referring to FIGS. 1-8, a cable assembly 1000 in accordance with the present invention comprises an insulative housing 1, a terminal module 2, two latching members 3, a metallic shell 4, an external cover 5, a cable 6, a strain relief 7, an optical module 8 and two spring members 9.

The insulative housing 1 includes a main portion 10 and two mounting arms 12 extending rearwardly from lateral sides of the main portion 10. A receiving space 102 is recessed forwardly from a middle segment of a rear edge of the main portion 10. A cavity 104 is recessed downwardly from a front segment of an upper side of the main portion 10 and further communicates with the receiving space 102. A depression 105 is defined in a front section of a lower side of the main portion 10. There is a bar 1050 crossing the front of the depression 105 and connecting with lateral sides of the depression 105. In addition, there is a supporting portion 1051 disposed in a middle segment of the depression 105 and located between the bar 1050 and a bottom surface of the depression 105. Two guiding slots 103 are located in a back section of the lower side of the main portion 10. The two guiding slots 103 spaced apart from each other along a transversal direction. Four grooves 106 are defined in the back section of the lower side of the main portion 10, and there are two of the grooves 106 disposed between the two guiding slots 103 and the other two grooves 106 respectively located at outside of the two guiding slots 103. A slot 101 is defined in the mounting arm 12 and partial of main portion 10 in front of the mounting arm 12.

The terminal module 2 includes a first terminal module 21 and a second terminal module 22. The first terminal module 21 has an insulator 211 and a number of terminals 212 combined together by insert-molding process. The terminals 212 are divided into signal terminals and grounding terminals configured to be longer than the signal terminals. The terminals 212 have contacting portions 2120 disposed in front of an edge of the insulator 211 and tail portions (not numbered) which are accommodated in terminal slots 2112 defined in a back segment of the insulator 211. Two mounting holes 2110 are defined in a bottom side of the insulator 211 and a protruding portion 2111 are formed on a top side of the insulator 211.

The second terminal module 22 has an insulator 221 and a number of terminals 222 combined together by insert-molding process. The terminals 222 are divided into signal terminals and grounding terminals configured to be longer than the signal terminals. The terminals 222 have contacting portions 2220 disposed in front of an edge of the insulator 221 and tail portions (not numbered) which are accommodated in terminal slots 2212 defined in a back segment of the insulator 221. Two mounting posts 2210 are formed on a top side of the insulator 221. There are two protruding portions 2214 formed on a bottom side of a back segment of the insulator 221. In addition, there are four passages 2216 defined in the bottom side of the back segment of the insulator 221 and extending along a front-to-back direction.

The first terminal module 21 and the second terminal module 22 are assembled together, with the contacting portions 2120, 2220 merged into one row, while the tail portions separated into two distinct rows along an up-to-down direction. The mounting posts 2210 are inserted into the mounting holes 2110 so as to keep the first terminal module 21 and the second terminal module 22 together. The first terminal module 21 and the second terminal module 22 are assembled to the insulative housing 1, with front segments of the insulators 211, 221 inserted into the receiving space 102, back segments of the insulators 211, 221 disposed between the two mounting arms 12, the contacting portions 2120, 2220 extending into the cavity 104.

Each latching member 3 includes a connecting arm 30, a latching arm 32 and a retention arm 33. The latching arm 32 and the retention arm 33 are spaced apart from each other and extend forwardly from the connecting arm 30. The latching arm 32 and the retention arm 33 are located in a first vertical plane. The connecting arm 30 is of U-shaped and locate in second vertical plane which is disposed outside the first vertical plane. A tab 324 is formed on a top side of the latching arm 32 and proximate the first bridge portion 311. The retention arm 33 is inserted into a positioning hole (not numbered) of the mounting arm 12, and the latching arm 32 is received in the slot 101 of the insulative housing 1. The connecting arm 30 is located behind the mounting arm 12 and adjacent to an outer surface of the mounting arm 12, therefore, more space is left inside the connecting arm 30.

The metallic shell 4 has a first shell 41, a second shell 42 and a third shell 43. The first shell 41 includes a frame 411 to accommodate the main portion 10 therein. Two through holes 4110 are defined in a front segment of a top side 411a of the frame 411 to allow hooks 322 of the latching arm 32 passing through. A first engaging portion 4110a projects backward from the top side 411a. There is a positioning hole 4112 defined in the first engaging portion 4110a to latch with the protruding portion 2111 of the first terminal module 21. The frame 411 has a bottom side 411b suitably matching with the depression 105 of the insulative housing 1. A second engaging portion 4110b projects backward from the bottom side 411b. There are two positioning holes 4114 defined in the second engaging portion 4110b to latch with the protruding portions 2214 of the second terminal module 22. In addition, there is a transversal cutout 4112b defined in a front segment of the bottom side 411b for accommodating the bar 1050.

The second shell 42 includes a U-shaped main body 421 and a cable holder 423 integrated with the main body 421 and projecting backwardly. The third shell 43 includes an inverted U-shaped main portion 431 and a tail 433 extending rearward. The second shell 42 and the third shell 43 can be combined together along a vertical direction.

The external cover 5 includes an upper cover 51 and a bottom cover 52. The upper cover 51 has a first hollow 511 and a second hollow 512 disposed behind the first hollow 511. A rectangular shaped opening 5110 is located in the front portion of the upper cover 51, and the opening 5110 further communicates with the first hollow 511. A semicircular shaped outlet 513 is defined in the rear portion of the upper cover 51 and communicated with the second hollow 512. A deformable button 514 is integrally formed with the upper cover 51 and floatable along up-to-down direction to enter the first hollow 511 so as to actuate the tab 324 of the latching arm 32.

The bottom cover 52 is similar to the upper cover 51, and also has a first hollow 521 and a second hollow 522 disposed behind the first hollow 521. An opening 5210 is located in the front portion of the bottom cover 52, and the opening 5210 further communicates with the first hollow 521. A semicircular shaped outlet 523 is defined in the rear portion of the bottom cover 52 and communicated with the second hollow 522.

The cable 6 includes a number of wire groups and a number of fibers 65 enclosed in a jacket 60 thereof. Each wire group includes a pair of signal wires 61 and a grounding wire 62 disposed aside the pair of wires 61, and a shielding member 63 shrouding the pair of wires 61. The shielding member 63 is aluminum foil or other similar structure. The strain relief member 7 is molded over a front segment of the cable 6.

The signal wires 61 and the grounding wires 62 are put into terminal slots 2112, 2222 of the insulators 211, 221 and soldered to the tails of the terminals 212, 222. The strain relief member 7 is accommodated in the second hollows 512, 522.

The optical module 8 includes a number of lenses 81, a seat 83 for supporting the lenses 81 and two guiding members 85 extending backwardly from a back side of the seat. The lenses 81 are arranged in a row along a transversal direction and embedded in the seat 83. In addition, the lenses 81 extend beyond front side of the seat 83, with a gap formed front portions of every two adjacent lenses 81. The fibers 65 are respectively coupled to the lenses 81.

The optical module 8 is assembled to the depression 105 of the insulative housing 1, and the two spring members 9 are respectively mounted to the guiding members 85, with ends of the guiding members 85 respectively received in the two guiding slots 103, and the spring members 9 is sandwiched between the seat 83 and a back edge of the depression 105 to forwardly bias the optical module 8. There are four lenses 81 with four front portions disposed in front of the seat 83 and supported by the bar 1050. In addition, the seat 83 of the optical module 8 is also stopped by a supporting portion 1050.

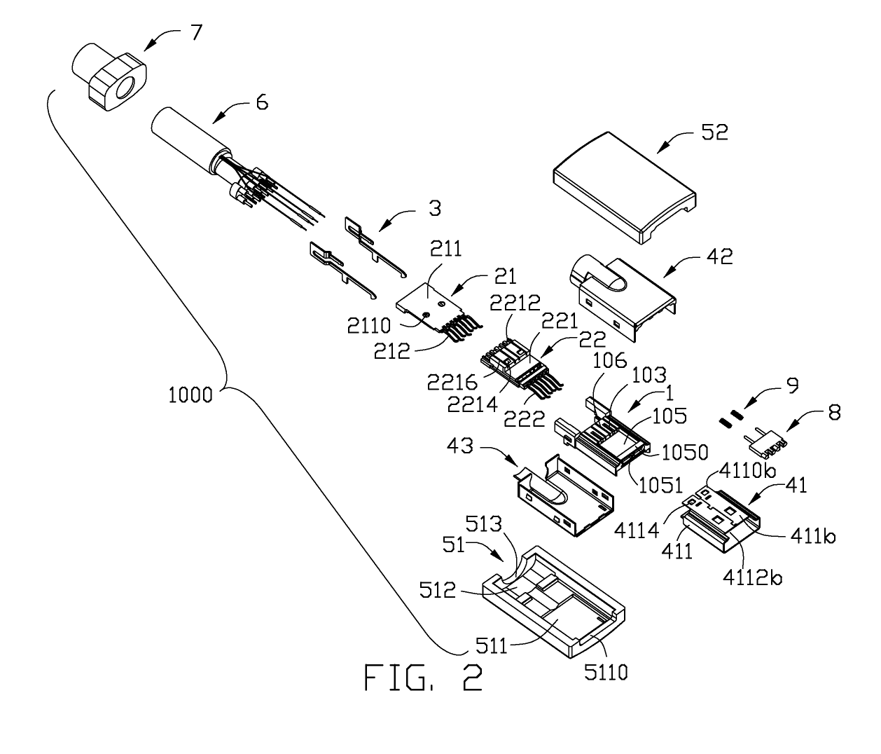

An arrangement of the terminals 212, 212 is in accordance with Digital Interactive Interface for Video & Audio (DiiVA) standard. Referring to FIG. 1-2, within the cavity 104, along a left-to-right direction, there are thirteen terminals which are arranged in such manner: G-S-S-G-S-S-G-S-S-G-G-S-S. G represents grounding terminal, and S represent signal terminal. There are three differential pairs consisted of six signal terminals located between grounding terminals. The differential pairs for high-speed transmitting used for conveying video signals. And a pair of signal terminals disposed in the right side cavity 104 used for audio signals.

When detach the cable assembly 100 from a complementary connector, just press the deformable button 514 to actuate the tab 324 of the latching arm 32, and the latching arm 32 retreat into the slots 101. When the pressing force is withdrawn, the deformable button 514 restored to its original position, and the latching arms 32 also upwardly movement by rebounded force of the resilient tabs 304.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A cable assembly, comprising:
an insulative housing having a cavity and a depression respectively located in an upper side and a lower side of a front segment thereof;
a plurality of terminals received in the insulative housing, with contacting portions thereof accommodated in the cavity;
an optical module accommodated in the depression, said optical module having a seat and a number of lenses supported by the seat; and
a cable having a plurality of wires and fibers connected to the terminals and the lenses, respectively.

2. The cable assembly as recited in claim 1, wherein the lenses are arranged in a row along a transversal direction and embedded in the seat.

3. The cable assembly as recited in claim 2, wherein the optical module is capable of sliding along the depression.

4. The cable assembly as recited in claim 3, wherein there is at least one spring member sandwiched between the seat and a back edge of the depression.

5. The cable assembly as recited in claim 1, further comprising a metallic shell with a frame accommodating the insulative housing therein.

6. The cable assembly as recited in claim 5, wherein there is a bar crossing a front portion of the depression.

7. The cable assembly as recited in claim 6, wherein there is a transversal cutout defined in a bottom side of the frame and the bar extends into the transversal cutout.

8. The cable assembly as recited in claim 6, wherein front portions of the lenses disposed in front of the seat and are supported by the bar.

9. The cable assembly as recited in claim 8, wherein there is a supporting portion disposed between the bar and a bottom surface of the depression, and the seat of the optical module is stopped by the supporting portion.

10. A cable assembly, comprising:
an insulative housing having a cavity and a depression respectively located in an upper side and a lower side of a front segment thereof, and a receiving space recessed forwardly from a rear edge of the main portion and communicating with the cavity;
a terminal module including a first terminal module and a second terminal module both having an insulator and a number of terminals combined with the insulator, the terminals having a number of contacting portions disposed in front of the insulator, and the terminal module assembled to the receiving space, with the contacting portions extending into the cavity;
an optical module accommodated in the depression, the optical module having a seat and at least one lens mounted into the seat; and
a cable having a plurality of wires and a corresponding fiber connected to the terminals and the lens, respectively.

11. The cable assembly as recited in claim 10, wherein the contacting portions of the terminals are arranged in a row along a transversal direction.

12. The cable assembly as recited in claim 10, wherein the terminals includes six signal terminals divided into three sets of differential pairs spaced apart from each other by grounding terminals.

13. The cable assembly as recited in claim 12, wherein contacting portions of the terminals of the first terminal module and the second terminal module are arranged in one row along a transversal direction.

14. The cable assembly as recited in claim 13, wherein the first terminal module and the second terminal module are assembled to each other along a vertical direction.

15. The cable assembly as recited in claim 12, wherein there are two guiding members extending backwardly from a back side of the seat and two guiding slots located in a back section of the lower side of the insulative housing to accommodate the two guiding members, respectively.

16. The cable assembly as recited in claim 15, wherein there are two springs respectively assembled to the two guiding members.

17. A cable connector assembly comprising:
an insulative housing defining a horizontal electrical mating face and a vertical optical mating face in front of said electrical mating face;
an electrical terminal module receiving space formed behind the optical mating face in a front-to-back direction;
an optical module receiving space located behind the electrical mating face in said front-to-back direction and behind the electrical mating face in a vertical direction perpendicular to said front-to-back direction;
an electrical mating port formed in front of the electrical mating face in another vertical direction opposite to said vertical direction;
an electrical terminal module discrete from the housing and received in the electrical terminal module receiving space and integrally equipped with terminals having resilient forwardly extending contacting sections exposed upon the electrical mating face and into the electrical mating port;
an optical module received in the optical module receiving space and back and forth moveable relative to the housing in said front-to-back direction, said optical module equipped with lenses approximate the optical mating face in the front-to-back direction;
a cable including a plurality electrical wires respectively electrically connected to the corresponding terminals, and a plurality of optical fibers respectively optically connected to the corresponding lenses.

18. The cable connector assembly as claimed in claim 17, wherein the electrical terminal modules includes two units stacked with each other in the vertical direction and respectively equipped with the corresponding terminals under condition that tail sections of the terminals in said two units are arranged in two rows so as to separate from each other in the vertical direction while the contacting sections are arranged in one row for commonly being exposed upon the electrical mating face and into the electrical mating port.
